(19) United States
(12) Patent Application Publication
(10) Pub. No.: US 2004/0222256 A1
(43) Pub. Date: Nov. 11, 2004

(54) Package storage assembly and installation method

(76) Inventors: Alvin D. McCauley, Holly, MI (US); David B. Gronzo, Davisburg, MI (US); Ben V. Domas, Oakland, MI (US)

Correspondence Address: REISING, ETHINGTON, BARNES, KISSELLE, P.C., P O BOX 4390, TROY, MI, 48099-4390, US

(21) Appl. No.: 10/834,441

(22) Filed: Apr. 29, 2004

Related U.S. Application Data
(60) Provisional application No. 60/466,483, filed on Apr. 29, 2003.

(51) Int. Cl. B60R 7/00

(52) U.S. Cl. 224/29.5

(57) ABSTRACT

A package storage assembly including a loft panel for carrying objects over the seating area of a mass transit vehicle passenger compartment is installed by forming the loft panel as a single homogeneous unitary piece, then connecting an elongated base member to an inner edge of the loft panel and connecting lower ends of a plurality of spaced-apart generally vertical stanchions to the base member. An elongated wall bracket having an elongated recess is mounting in a horizontal orientation on along an interior side wall of a vehicle. The loft panel is then supported in a generally horizontal attitude by supporting its outer edge in the elongated recess of the wall bracket and connecting upper ends of the stanchions to the ceiling of the vehicle.

### CROSS-REFERENCES TO RELATED APPLICATIONS

This application claims priority from Provisional application Serial No. 60/466,483, filed Apr. 29, 2003 and entitled Package Storage Assembly and Installation Method, which is incorporated by reference.

### STATEMENT REGARDING FEDERALLY SPONSORED RESEARCH OR DEVELOPMENT

Not Applicable

### BACKGROUND OF THE INVENTION

1. Field of the Invention

This invention relates generally to a package storage assembly for supporting packages over the seating area of a mass transit vehicle passenger compartment and a method for installing such an assembly.

2. Description of the Related Art Including Information Disclosed Under 37 CFR 1.97 and 1.98

Package storage assemblies or package racks for supporting packages over the seating area of a mass transit vehicle passenger compartment are well known. Such an assembly will generally include one or more loft panels supported along an outer edge by being attached to an interior side wall of the vehicle and supported along an outer edge by a base member that is, in turn, supported by one or more stanchions that connect between the base member and a ceiling of the passenger compartment.

For example, U.S. Pat. No. 5,441,326 issued to Mikalonis on Aug. 15, 1995 and assigned to Transmatic, Inc., discloses a package rack for use in a mass transit vehicle and including a plurality of plastic loft panels. The loft panels are supported along respective inner and outer edges and each include a sheet of wood molded into each panel for structural stiffness.

The inner edges of the panels are supported by an elongated base member that's fixed to the inner edges of the loft panels and suspended from a ceiling of the vehicle by stanchions. The outer edges are supported by a wall bracket attached to an interior side wall of the vehicle. Each loft panel includes an elongated hooked section formed along its outer edge. The elongated recess is shaped to receive this hooked or bent section in a roll-in type engagement.

The base member includes an elongated recess shaped to slidably receive bolt heads and a plurality of spaced vertical stanchions connected at respective lower ends to bolts whose heads are slidably supported in the base member channel. An elongated bracket is fixed to the ceiling of the vehicle and is bolted to upper ends of the stanchions.

In addition, U.S. Pat. No. 6,241,861issued to Calnon on Jun. 5, 2001 and assigned to Transmatic Europe Limited, discloses a method for installing a luggage rack that includes first engaging an outer edge of a loft panel of the rack to a wall of the vehicle, then supporting an inner edge of the loft panel by attaching lower ends of vertical stanchions along the rack inner edge and upper ends of the stanchions to ceiling bolts.

U.S. Publication No. U.S. 2002/0030374, which lists Herman Myburgh as inventor and has a publication date of 14 Mar. 2002, discloses a single piece loft panel supported along an outer edge on a wall of the vehicle and along an inner edge by vertical stanchions. The Myburgh loft panel is a composite panel that includes a plastic core and metal skins. The Myburgh loft panel is bent into a desired configuration to serve as a loft panel.

What is needed is a package storage assembly for supporting packages over the seating area of a mass transit vehicle passenger compartment that includes loft panels that are easier and less expensive to manufacture. What is also needed is a method for installing such loft panels that is quick and efficient.

### BRIEF SUMMARY OF THE INVENTION

A package storage assembly for supporting packages over the seating area of a mass transit vehicle passenger compartment is provided that includes a loft panel configured to carry objects when supported in a generally horizontal attitude along loft panel inner and outer edges. An elongated wall bracket is configured to be fixed horizontally along an interior side wall of a vehicle and has an elongated recess configured to receive the loft panel outer edge. The package storage assembly also includes an elongated base member connected to the loft panel inner edge, a plurality of spaced-apart generally vertical stanchions connected at respective lower ends to the base member and connectable at respective upper ends to the ceiling of the vehicle. Unlike the prior art, the loft panel of the package storage assembly comprises a single homogeneous unitary piece. The use of a single homogenous loft panel simplifies manufacture and assembly while providing sufficient stiffness to support objects when the loft panel is supported only along opposite inner and outer edges.

According to another aspect of the invention, the loft panel includes transverse ribs to add stiffness.

According to another aspect of the invention, the assembly further includes an accessory housing supported on an upper surface of the loft panel, the housing being accessible from below through an opening formed through the loft panel.

According to another aspect of the invention, the opening is formed in one of the ribs and the accessory housing is supported in a position spanning the opening.

According to another aspect of the invention, the base member includes an elongated base member recess configured to receive the outer edge of the loft panel.

According to another aspect of the invention, the base member recess has an inverted T-shaped cross section defined by an upright channel portion opening upward along a top surface of the base member and a transverse channel portion intersecting a lower end of the upright channel portion; the loft panel includes an elongated loft panel inner hook formed along the loft panel inner edge and shaped to be received in the base member recess in a roll-in type engagement.

According to another aspect of the invention, the loft panel inner hook includes a generally vertical upright portion shaped to fit within the upright channel portion and a lip portion that extends integrally and laterally inward from along a lower end of the upright portion and is shaped to fit within an inner portion of the transverse channel portion of the base member recess.

According to another aspect of the invention, each stanchion includes an engagement key having an inverted T-shape and extending integrally axially downwardly from the lower end of each stanchion, each elongated key being slidably retained in the base member recess so that the stanchions can be slid longitudinally along the base member when attached to the base member.

According to another aspect of the invention, the base member is an aluminum extrusion.

According to another aspect of the invention, the loft panel includes an elongated loft panel outer hook formed along the loft panel outer edge, and the elongated wall bracket recess is configured to receive the loft panel outer hook in a roll-in type engagement.

According to another aspect of the invention, the wall bracket comprises extruded aluminum.

According to another aspect of the invention, the assembly includes an elongated ceiling bracket fixed to the ceiling of the vehicle and including an elongated ceiling bracket recess. A plurality of sliders are slidably supported within the ceiling bracket recess and are configured to connect to upper ends of the stanchions to support the inner edge of the loft panel.

According to another aspect of the invention, each slider includes a receptacle configured to receive the upper end of a stanchion. Two diametrically opposed holes are formed through opposite walls of the receptacle, and each stanchion includes a pair of outwardly biased pins carried in diametrically opposed holes formed through the upper end of each stanchion. The pins are configured to align with and snap outwardly into engagement with the diametrically opposed holes in the receptacle when a stanchion is pushed into the receptacle.

According to another aspect of the invention, the assembly further includes trim panels configured to be snapped along the ceiling bracket between the sliders to prevent passengers from inadvertently or purposefully disengaging the stanchion pins.

According to another aspect of the invention, the assembly further includes a plurality of receptacles fixed at predetermined locations along the ceiling of a vehicle, and each stanchion is configured to be individually engaged with and supported by one of the receptacles.

According to another aspect of the invention, the assembly includes a plurality of the loft panels arranged end to end along at least a portion of the length of a vehicle passenger compartment and supported along respective inner and outer edges. The elongated wall bracket recess is configured to receive the loft panel outer edges, and the base member is connected to and extends along the loft panel inner edges.

According to another aspect of the invention, each loft panel includes at least one upstanding side flange positioned to be fastened to an upstanding flange of an adjacent loft panel to prevent the loft panels from separating.

According to another aspect of the invention, an accessory housing is supported in a position spanning respective top surfaces of two adjacent loft panels and is accessible from below through an opening formed in the panels.

The invention also includes a method for installing a package storage assembly in a transit vehicle compartment. The method includes connecting a loft panel to an elongated base member along an inner edge of the loft panel. Lower ends of stanchions are connected at spaced locations to the base member. An outer edge of the loft panel is then connected to the interior wall of a vehicle and upper ends of the stanchions are connected to the ceiling of the vehicle. According to this method, the panel and stanchions can be unpacked and immediately installed in a vehicle without having to first assemble the assembly at the installation site.

According to another aspect of the inventive method, the step of connecting the loft panel to the base member along the loft panel inner edge includes rolling an elongated inner hook of the loft panel into an elongated base member recess.

According to another aspect of the inventive method, the step of connecting the lower ends of the stanchions to the base member includes inserting stanchion engagement keys into the elongated base member recess.

According to another aspect of the inventive method, the step of connecting the lower ends of the stanchions to the base member includes sliding the stanchions along the base member into respective desired positions.

According to another aspect of the inventive method, the step of connecting the outer edge of the loft panel to the interior wall of a vehicle includes rolling the loft panel outer hook into the wall bracket recess.

According to another aspect of the inventive method, the step of connecting the upper ends of the stanchions to the ceiling of the vehicle includes connecting a ceiling bracket to the ceiling of the vehicle compartment, providing sliders in the ceiling bracket recess, and connecting the upper ends of the stanchions to the sliders.

According to another aspect of the inventive method, the step of connecting the upper ends of the stanchions to the ceiling of the vehicle includes inserting the upper ends of the stanchions into slider receptacles of the sliders until diametrically opposed holes in the receptacles are aligned with diametrically opposed holes of each stanchion and outwardly biased pins disposed within the stanchion holes snap outwardly into engagement with the diametrically opposed receptacle holes.

According to another aspect of the inventive method, the step of connecting the upper ends of the stanchions to the ceiling of the vehicle includes connecting a plurality of receptacles at predetermined fixed locations along the ceiling of a vehicle, and connecting the upper ends of the stanchions to the respective receptacles.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is a fragmentary front view of a package storage assembly constructed according to the invention and showing a single loft panel of the assembly supported by three stanchions of the assembly;

FIG. 2 is a fragmentary bottom view of the package storage assembly of FIG. 1;

FIG. 3 is an end view of the package storage assembly of FIGS. 1 and 2;

FIG. 4 is a cross-sectional end view of the package storage assembly of FIGS. 1-3 shown installed in the cornice area of a transit vehicle passenger compartment;

FIG. 5 is a top view of two package storage assemblies constructed according to the invention and installed in respective opposite cornice areas of a transit vehicle passenger compartment;

FIG. 6 is a cross-sectional end view of the package storage assemblies of FIG. 5 shown installed in respective opposite cornice areas of a transit vehicle passenger compartment;

FIG. 7 is a magnified cross-sectional end view of a junction between a loft panel and a stanchion of the package storage assembly of FIGS. 1-3;

FIG. 8 is a magnified cross-sectional view of end flanges of two adjacent loft panels of the package storage assembly of FIGS. 1-3 shown fastened together;

FIG. 9 is a cross-sectional end view of a package storage assembly constructed and installed according to an alternative embodiment of the invention and shown installed in the cornice area of a transit vehicle passenger compartment;

FIG. 10 is a cross-sectional view of an accessory lamp panel of the package storage assembly of FIG. 9 shown mounted on an upper surface of a rib of a loft panel of that package storage assembly; and

FIG. 11 is an exploded view of a ceiling bracket, slider, and stanchion connection of the package storage assembly of FIG. 9.

### DETAILED DESCRIPTION OF INVENTION EMBODIMENT(S)

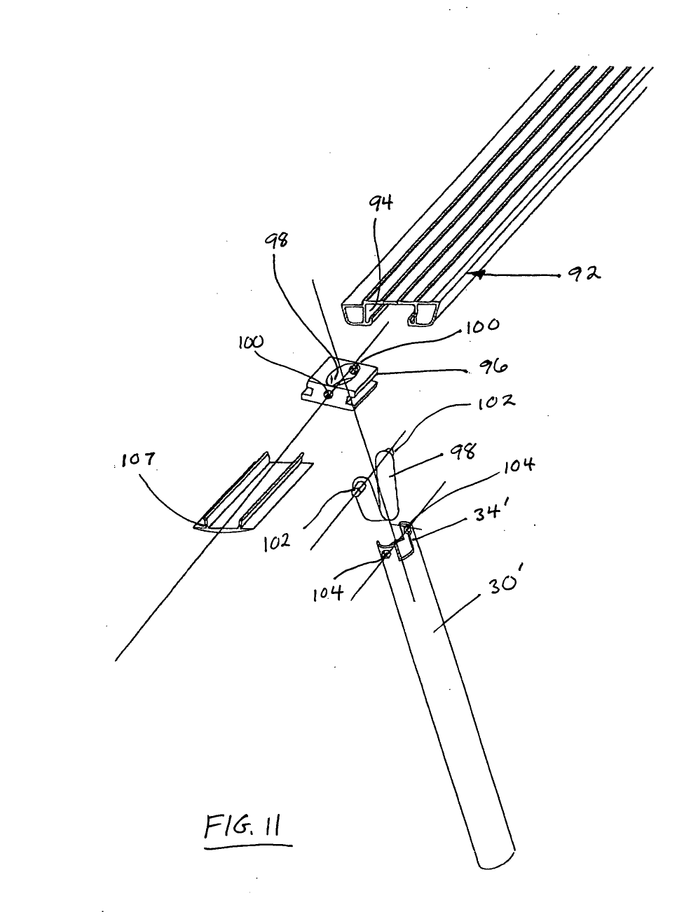

A first embodiment of a package storage assembly for supporting packages over the seating area 12 of a mass transit vehicle passenger compartment 14 is generally indicated at 10 in FIGS. 1-8, 11, and 12. A second embodiment of such an assembly is generally indicated at 10′ in FIG. 9. A portion of the second embodiment is also shown in FIG. 10. Reference numerals with the designation prime (′) in FIGS. 9 and 10 indicate alternative configurations of elements that also appear in the first embodiment. Unless indicated otherwise, where a portion of the following description uses a reference numeral to refer to the figures, that portion of the description applies equally to elements designated by primed numerals in FIGS. 9 and 10.

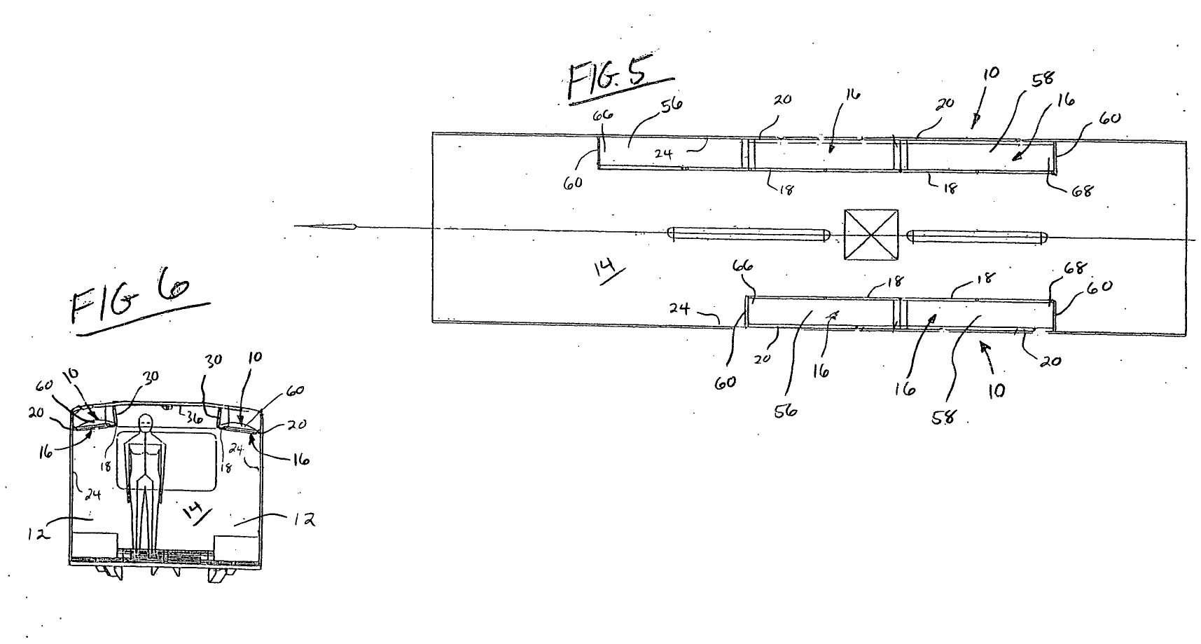

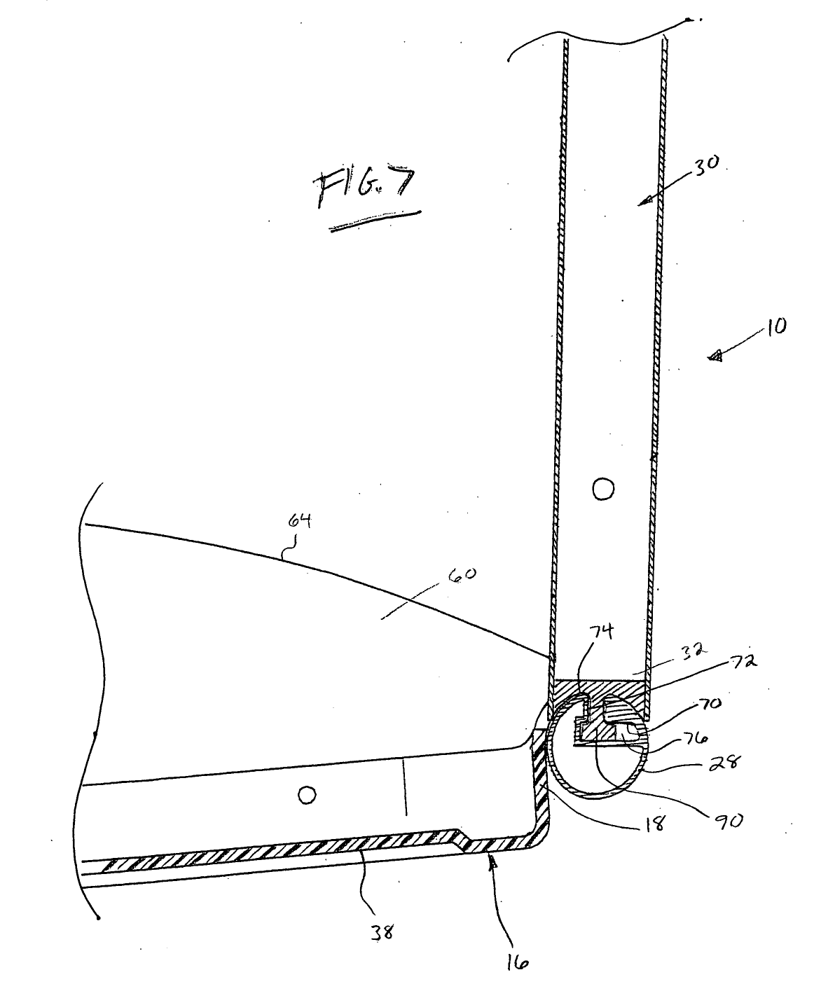

As best shown in FIG. 4, the assembly 10 includes one or more loft panels 16 supportable along respective loft panel inner and outer edges 18, 20. As shown in FIG. 5, when the assembly 10 includes more than one loft panel 16, the panels 16 are arranged end to end along at least a portion of the length of a vehicle passenger compartment 14. The loft panels 16 are formed in such a way as to have sufficient stiffness to carry objects such as packages and handbags when the loft panels 16 are supported in respective generally horizontal attitudes along their respective loft panel inner and outer edges 18, 20. The assembly 10 also includes an elongated wall bracket shown at 22 in FIG. 4. The wall bracket 22 is supportable in a horizontal attitude along an interior sidewall 24 of a vehicle passenger compartment 14. The elongated wall bracket 22 includes an elongated generally horizontal wall bracket recess 26 that receives and supports the outer edges 20 of the loft panels 16. Also included in the assembly 10 is an elongated base member 28 that is connected to and extends along the loft panel inner edges 18. The base member 28 has a generally cylindrical shape and additionally serves as a hand rail for passengers. Also, a plurality of generally parallel spaced apart generally vertical tubular stanchions 30 are connected at respective stanchion lower ends 32 to the base member 28 and are connectable at respective stanchion upper ends 34 to a ceiling 36 of the vehicle.

The loft panel 16 is formed a single homogeneous unitary piece that is simple to manufacture, requires no assembly, yet provides sufficient stiffness to support objects when the loft panel 16 is supported only along opposite inner and outer edges 18, 20 as described above. The loft panel 16 is molded from plastic, fiberglass, or any other suitable material. The loft panel 16 may alternatively be pultruded as a single unitary piece.

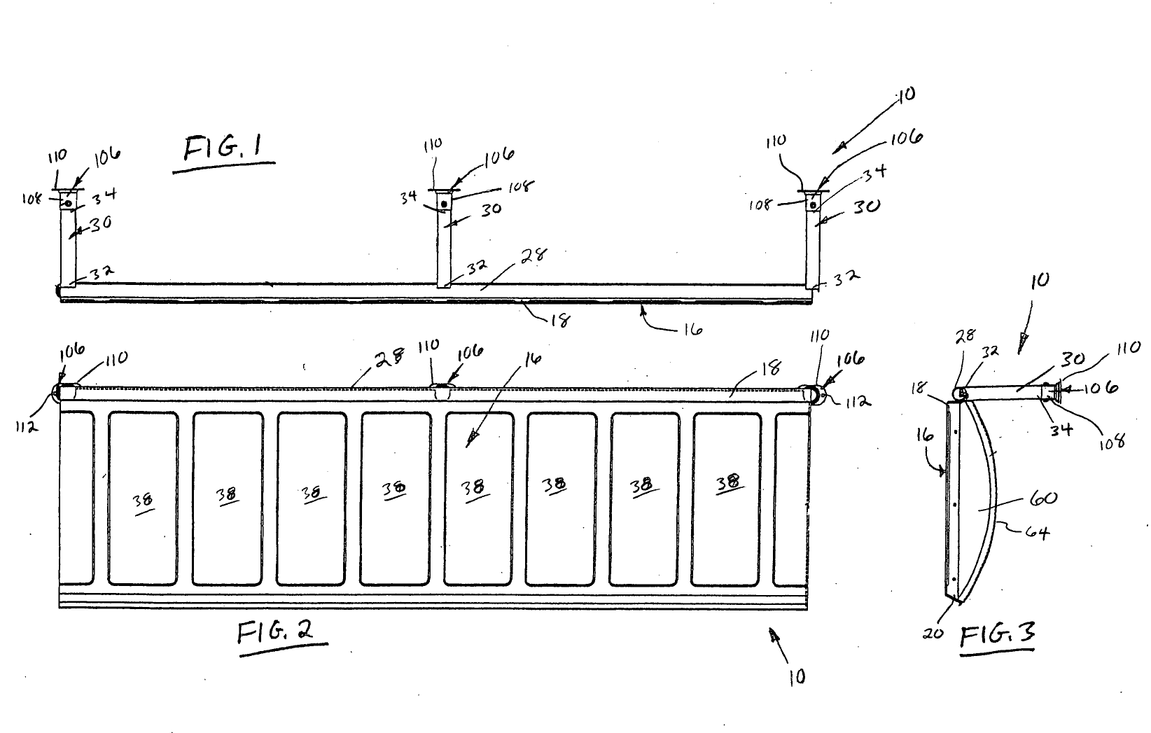

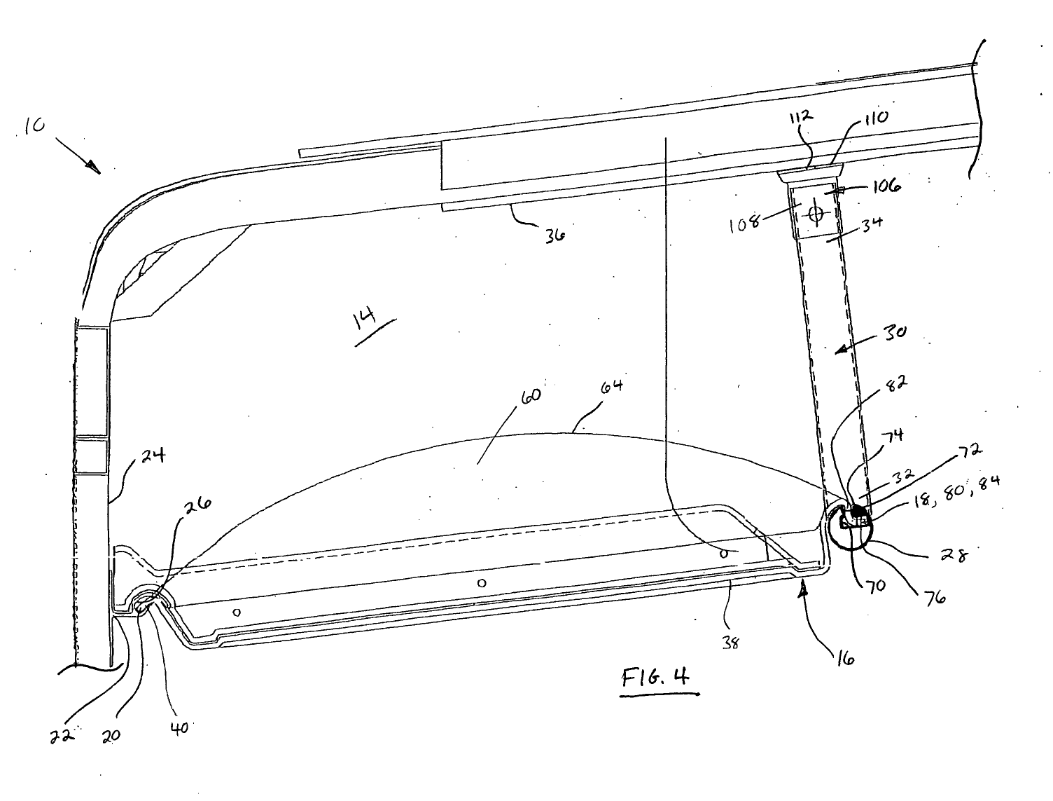

Each loft panel 16 includes transverse ribs 38 comprising flat rectangular depressions molded into each loft panel 16 as shown in FIGS. 2, 4, and 7. The ribs 38 are formed into the loft panels 16 to add stiffness to the loft panels 16.

As shown in FIG. 4, each loft panel 16 includes an elongated loft panel outer hook 40 formed along the outer edge 20 of each loft panel 16. The elongated wall bracket recess 26 is shaped to receive the outer hooks 40 of the loft panels 16 in a roll in type engagement. The wall bracket 22 comprises extruded aluminum and is extruded such that the cross-sectional shape of the bracket, including the wall bracket recess 26, is generally constant along the length of the wall bracket 22.

Each loft panel 16 may include one or more upstanding side flanges 52, each positioned to be fastened by rivets to an upstanding flange 54 of an adjacent loft panel 16 as shown in FIG. 8. By riveting the adjacent flanges 52, 54 together, the loft panels 16 are prevented from separating and further stiffness is added to the assembly 10. As shown in FIGS. 3-7, end loft panels 56, 58 positioned at opposite ends of a series of interconnected loft panels 16 include larger side flanges 60 that extend farther upward than the flanges 52, 54 of intermediate loft panels 62, and that extend upward to arcuate upper edges 64. These taller side flanges 60 prevent objects supported on the loft panels 16 from sliding off forward or aft ends 66, 68 of the assembly 10.

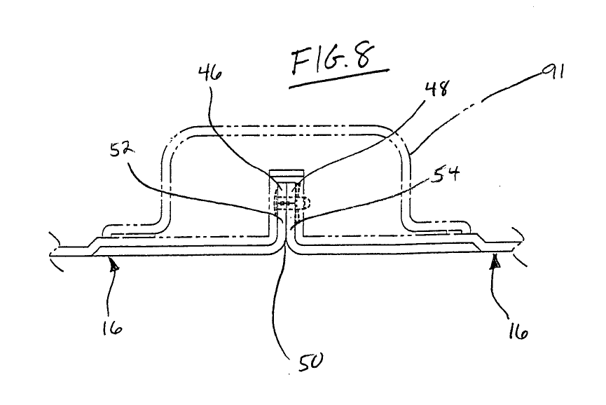

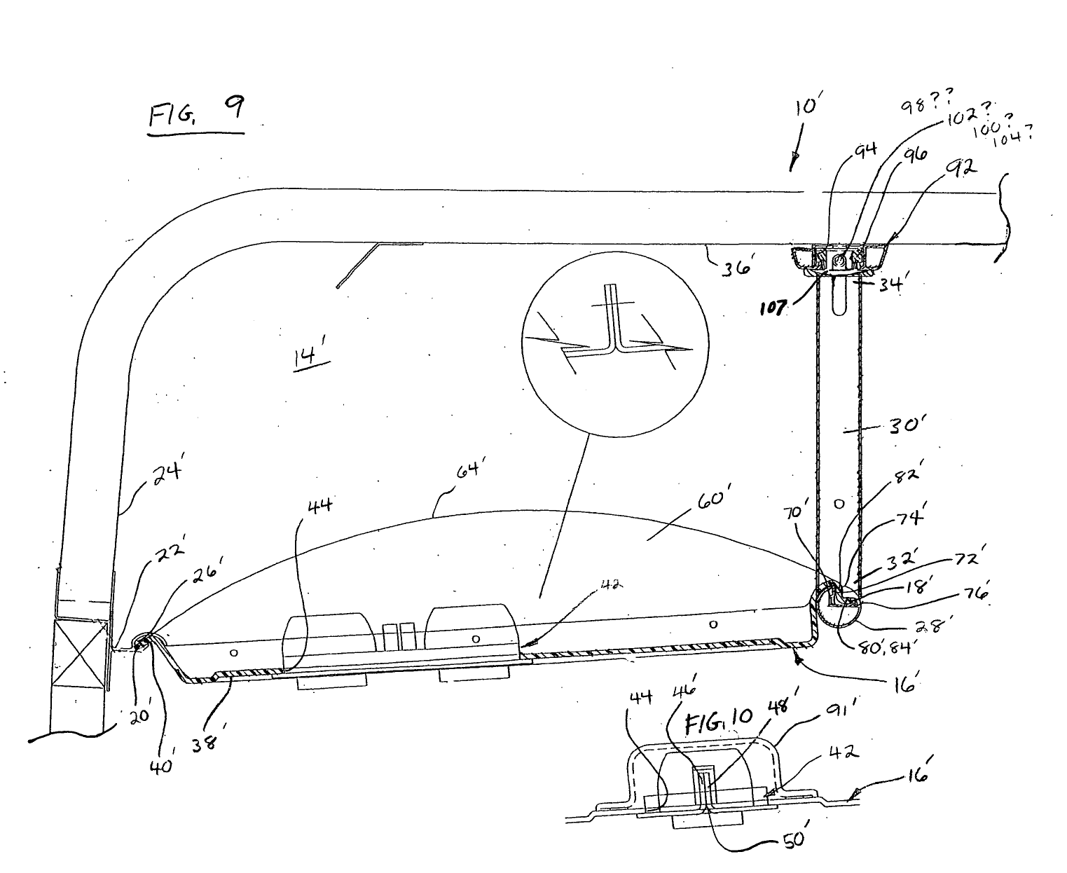

The base member 28 includes an elongated base member recess 70 that receives and supports the outer edges 20 of the loft panels 16 as shown in FIG. 4 and also receives and engages the lower ends 32 of the stanchions 30 as shown in FIG. 7. The base member recess 70 has an inverted T-shaped cross section defined by an upright channel portion 72 opening upward along a top surface 74 of the base member 28 and a transverse channel portion 76 intersecting a lower end of the upright channel portion 72.

As shown in FIG. 4, each loft panel 16 includes an elongated loft panel inner hook 80 formed along the inner edge 18 of each loft panel 16 and shaped to be received in the base member recess 70 in either a lateral roll-in type engagement or a longitudinal slide-in type engagement. The inner hook 80 of each loft panel 16 includes a generally vertical upright portion 82 shaped to fit within the upright channel portion 72. Each loft panel inner hook 80 also includes a rib portion 84 that extends integrally and laterally inward from along a lower end 86 of the upright channel portion 72 and is shaped to fit within the transverse channel portion 76 of the base member recess 70.

As shown in FIG. 7, each stanchion 30 includes an engagement key 90 having an inverted T-shape and extending integrally axially downwardly from the lower end 32 of each stanchion 30. Each engagement key 90 is slidably retained in the base member recess 70 so that the stanchions 30 can be slid longitudinally along the base member 28 when attached to the base member 28. The base member 28 is an aluminum extrusion having a uniform cross section along its length. The base member recess 70 also has a uniform cross sectional shape along its length.

As shown in FIG. 8, an elongated channel 91, having a uniform cross section along its length, may be attached to an upper surface of one or more of the loft panels 16 to restrain packages and other stored items against sliding longitudinally. The elongated channel 91 may be attached at any point along the length of a loft panel 16 or may, as shown in FIG. 8, straddle the junction 50 of two abutting loft panels 16.

As best shown in FIGS. 1-4, the assembly 10 includes a plurality of T-receptacles 106 fixed at predetermined locations along the ceiling 36 of a vehicle passenger compartment 14. Each stanchion 30 is individually engaged with and supported by one of the T-receptacles 106. Each T-receptacle 106 includes a vertical tubular section 108 shaped to receive a tubular upper end 34 of a stanchion 30 and a horizontally oriented flange 110 including through holes 112 for fasteners to be installed through the flange 110 and into a ceiling 36 of the vehicle passenger compartment 14.

In practice, a package storage assembly 10 constructed according to the invention and including at least one loft panel 16 can be installed by first connecting the loft panel 16 to the base member 28 along the loft panel inner edge 18 by rolling the loft panel inner hook 80 into the base member recess 70. The lower ends 32 of the stanchions 30 are then connected to the base member 28 by inserting the stanchion engagement keys 90 into the elongated base member recess 70 and sliding the stanchions 30 along the base member 28 into respective desired positions. The outer edge 20 of the loft panel 16 is then connected to the interior wall of a vehicle passenger compartment 14 by rolling the loft panel outer hook 40 into the wall bracket recess 26 of the wall bracket 22 after mounting the wall bracket 22 on the interior wall. The upper ends 34 of the stanchions 30 are then connected to the ceiling 36 by attaching a plurality of the T-receptacles 106 at pre-determined locations along the ceiling 36 of the vehicle, then connecting the upper ends 34 of the stanchions 30 to the respective T-receptacles 106.

According to the second embodiment, the assembly 10′ includes accessory housings as shown at 42 in FIGS. 9 and 10. The accessory housings 42 are supported transversely on the loft panels 16′. The accessory housings 42 house accessories accessible from below the loft panels 16′ through access openings 44′ formed through the loft panels 16′. The access openings 44′ are formed in the ribs 38′ of the loft panels 16′ and the accessory housings 42 are supported in respective positions spanning the access openings 44′.

As shown in FIG. 10, an accessory housing 42 may be supported on mating edges 46′, 48′ of two adjacent loft panels 16′ or across an intersection 50′ of the mating edges 46′, 48′. In this position, the presence of accessories at a loft panel intersection 50′ cosmetically masks the presence of a seam formed at the intersection 50′ between loft panels 16′.

The assembly 10′ of the second embodiment also includes an elongated extruded aluminum ceiling bracket as shown at 92 in FIGS. 9 and 11. The ceiling bracket 92 connects longitudinally along the ceiling 36′ of a vehicle passenger compartment 14′ and includes an elongated ceiling bracket recess 94. The ceiling bracket 92 has a uniform cross section along its length. The ceiling bracket recess 94 has a generally T-shaped cross-section shaped to receive a plurality of sliders 96 or carriages that are slidably supported within the ceiling bracket recess 94. The sliders 96 bolt or otherwise connect to upper ends 34′ of the stanchions 30′ to support the inner edges 18′ of the loft panels 16′.

As is best shown in FIG. 11, each slider 96 includes a slider receptacle 98 that receives the tubular upper end 34′ of a stanchion 30′. Two diametrically opposed receptacle holes 100 are formed through opposite walls of the slider receptacle 98. Each stanchion 30′ includes a pair of outwardly biased pins 102 carried in diametrically opposed stanchion holes 104 formed through the upper end 34′ of each stanchion 30′. The pins 102 align with and snap outwardly into engagement with the diametrically opposed receptacle holes 100 when the upper end 34′ of a stanchion 30′ is pushed into the slider receptacle 98.

As is also shown in FIGS. 9 and 11, the assembly 10′ further includes trim panels 107 shaped to be snapped along the ceiling bracket 92 between the sliders 96. The presence of the trim panels 107 between the sliders 96 prevents passengers from inadvertently or purposefully disengaging the stanchion pins 102.

In practice, according to this alternative embodiment, the upper ends 34′ of the stanchions 30′ are mounted on the ceiling 36′ of a vehicle passenger compartment 14′ by first connecting the ceiling bracket 92 to the ceiling 36′ of the passenger compartment 14′. The ceiling bracket 92 may be connected to the ceiling either with or without the sliders 96 already inserted into the ceiling bracket recess 94. If the sliders 96 have not been inserted before connecting the ceiling bracket 92 to the ceiling 36′, then the sliders 96 are inserted in the ceiling bracket recess 94 afterwards. The upper ends 34′ of the stanchions 30′ are then connected to the sliders 96 by inserting the upper ends 34′ of the stanchions 30′ into the slider receptacles 98. The upper ends 34′ of the stanchions 30′ are slid into the slider receptacles 98 until the diametrically opposed receptacle holes 100 are aligned with the diametrically opposed stanchion holes 104 and the outwardly biased pins 102 snap outwardly from the stanchion holes 104 into engagement with the receptacle holes 100.

This description is intended to illustrate certain embodiments of the invention rather than to limit the invention. Therefore, it uses descriptive rather than limiting words. Obviously, it's possible to modify this invention from what the description teaches and one may practice the invention other than as described.

What is claimed is:

1. A package storage assembly for supporting packages over the seating area of a mass transit vehicle passenger compartment, the assembly comprising:
a loft panel configured to carry objects when supported in a generally horizontal attitude along loft panel inner and outer edges;
an elongated wall bracket configured to be fixed horizontally along an interior side wall of a vehicle and having an elongated recess configured to receive the loft panel outer edge;
an elongated base member connected to the loft panel inner edge;
a plurality of spaced-apart generally vertical stanchions connected at respective lower ends to the base member and connectable at respective upper ends to the ceiling of the vehicle; and
the loft panel comprising a single homogeneous unitary piece to simplify manufacture and assembly while providing sufficient stiffness to support objects when the loft panel is supported only along opposite inner and outer edges.

2. A package storage assembly as defined in claim 1 in which the loft panel includes transverse ribs.

3. A package storage assembly as defined in claim 1 in which the assembly further includes an accessory housing supported on an upper surface of the loft panel, the housing being accessible from below through an opening formed through the loft panel.

4. A package storage assembly as defined in claim 3 in which the opening is formed in one of the ribs and the accessory housing is supported in a position spanning the opening.

5. A package storage assembly as defined in claim 1 in which the base member includes an elongated base member recess configured to receive the outer edge of the loft panel.

6. A package storage assembly as defined in claim 5 in which:
the base member recess has an inverted T-shaped cross section defined by an upright channel portion opening upward along a top surface of the base member and a transverse channel portion intersecting a lower end of the upright channel portion; and
the loft panel includes an elongated loft panel inner hook formed along the loft panel inner edge and shaped to be received in the base member recess in a roll-in type engagement.

7. A package storage assembly as defined in claim 6 in which the loft panel inner hook includes a generally vertical upright portion shaped to fit within the upright channel portion and a lip portion that extends integrally and laterally inward from along a lower end of the upright portion and is shaped to fit within an inner portion of the transverse channel portion of the base member recess.

8. A package storage assembly as defined in claim 6 in which each stanchion includes an engagement key having an inverted T-shape and extending integrally axially downwardly from the lower end of each stanchion, each engagement key being slidably retained in the base member recess.

9. A package storage assembly as defined in claim 1 in which the loft panel includes an elongated loft panel outer hook formed along the loft panel outer edge, and the elongated wall bracket recess is configured to receive the loft panel outer hook in a roll-in type engagement.

10. A package storage assembly as defined in claim 1 in which:
the assembly includes an elongated ceiling bracket fixed to the ceiling of the vehicle and including an elongated ceiling bracket recess; and
a plurality of sliders are slidably supported within the ceiling bracket recess and are configured to connect to upper ends of the stanchions to support the inner edge of the loft panel.

11. A package storage assembly as defined in claim 10 in which:
each slider includes a receptacle configured to receive the upper end of a stanchion;
a pair of diametrically opposed holes are formed through opposite walls of the receptacle; and
each stanchion includes a pair of outwardly biased pins carried in diametrically opposed holes formed through the upper end of each stanchion, the pins being configured to align with and snap outwardly into engagement with the diametrically opposed holes in the receptacle when a stanchion is pushed into the receptacle.

12. A package storage assembly as defined in claim 10 in which the assembly further includes trim panels configured to be snapped along the ceiling bracket between the sliders.

13. A package storage assembly as defined in claim 1 in which the assembly further includes a plurality of receptacles fixed at predetermined locations along the ceiling of a vehicle; and each stanchion is configured to be individually engaged with and supported by one of the receptacles.

14. A package storage assembly as defined in claim 1 in which:
the assembly includes a plurality of the loft panels configured to be arranged end to end along at least a portion of the length of a vehicle passenger compartment and supported along respective inner and outer edges;
the elongated wall bracket recess is configured to receive the loft panel outer edges; and
the base member is connected to and extends along the loft panel inner edges.

15. A package storage assembly as defined in claim 14 in which each loft panel includes at least one upstanding side flange positioned to be fastened to an upstanding flange of an adjacent loft panel.

16. A package storage assembly as defined in claim 14 in which an accessory housing is supported in a position spanning respective top surfaces of two adjacent loft panels and is accessible from below through an opening formed in the panels.

17. A method for making a package storage assembly and installation method, the method including the steps of:
connecting the loft panel to the base member along the loft panel inner edge;
connecting the lower ends of the stanchions to the base member;
connecting the outer edge of the loft panel to the interior wall of a vehicle; and
connecting the upper ends of the stanchions to the ceiling of the vehicle.

18. The method of claim 17 in which the step of connecting the loft panel to the base member along the loft panel inner edge includes:
providing in the base member an elongated base member recess;
forming an inner hook along the loft panel inner edge; and
rolling an inner hook of the loft panel into a base member recess.

19. The method of claim 18 in which the step of connecting the lower ends of the stanchions to the base member includes inserting the stanchion engagement keys into the elongated base member recess.

20. The method of claim 19 in which the step of connecting the lower ends of the stanchions to the base member includes sliding the stanchions along the base member into respective desired positions.

21. The method of claim 17 in which the step of connecting the outer edge of the loft panel to the interior wall of a vehicle includes:
forming an outer hook along the loft panel outer edge;
providing an elongated wall bracket horizontally along an interior side wall of the vehicle, the wall bracket having an elongated recess; and
rolling the loft panel outer hook into the wall bracket recess.

22. The method of claim 17 in which the step of connecting the upper ends of the stanchions to the ceiling of the vehicle includes:
connecting the ceiling bracket to the ceiling of the vehicle compartment;
providing the sliders in the ceiling bracket recess; and connecting the upper ends of the stanchions to the sliders.

23. The method of claim 22 in which the step of connecting the upper ends of the stanchions to the ceiling of the vehicle includes:
slidably supporting a plurality of sliders within the ceiling bracket recess;
providing in each slider a receptacle configured to receive the upper end of a stanchion;
providing a pair of diametrically opposed holes through opposite walls of the receptacle;
providing in each stanchion a pair of outwardly biased pins carried in diametrically opposed holes formed through the upper end of each stanchion; and
inserting the upper ends of the stanchions into the slider receptacles until the diametrically opposed receptacle holes are aligned with the diametrically opposed holes of each stanchion and the outwardly biased pins snap outwardly into engagement with the diametrically opposed holes in the receptacle.

24. The method of claim 17 in which the step of connecting the upper ends of the stanchions to the ceiling of the vehicle includes connecting a plurality of receptacles at predetermined locations along the ceiling of a vehicle, and connecting the upper ends of the stanchions to the respective receptacles.
